(19) United States
(12) Patent Application Publication
(10) Pub. No.: US 2015/0301708 A1
(43) Pub. Date: Oct. 22, 2015

(54) Video Editing Graphical User Interface

(71) Applicant: VMIX MEDIA, INC., San Diego, CA (US)

(72) Inventors: Gregory Paul Kostello, San Diego, CA (US); Sean Michael Meiners, San Diego, CA (US); Timothy Allan Flack, San Diego, CA (US); Philip Chen, Carlsbad, CA (US); Lonnie Jay Brownell, Encinitas, CA (US)

(73) Assignee: VMIX MEDIA, INC., San Diego, CA (US)

(21) Appl. No.: 14/257,909

(22) Filed: Apr. 21, 2014

(51) Int. Cl. G06F 3/0484; G11B 27/031; G06F 3/0488

(52) U.S. Cl. CPC G06F 3/0484; G06F 3/04883; G11B 27/031

(57) ABSTRACT

A video clip editor for use with a touch screen interface is provided. A slidable film reel element can be moved backwards and forwards to allow a user to specify which actions to take on particular frames within a video clip/segment. Related apparatus, systems, techniques and articles are also described.

### TECHNICAL FIELD

The subject matter described herein relates to a graphical user interface for editing video clips on a computing device having a touch-screen interface such as a mobile phone and a tablet computer.

### BACKGROUND

Video editing is a time consuming task and is often performed on desktop computer workstations with multiple screens and the like. However, increasing amounts of video are being generated and stored on mobile devices such as smartphone and tablet computers. Applications for video editing on mobile phones and tablet computers are often burdensome to use thereby discouraging their widespread adoption.

### SUMMARY

A video clip editor is rendered within a graphical user interface of a computing device that comprises a plurality of elements. The computing device has a touch screen interface for receiving user-generated input. The video clip editor includes a preview portion showing a currently selected frame of a video clip being edited, a slidable film reel element having an overlaid visual characterization of frames within the video clip, a set start element, and a set end element. At least one gesture (e.g., a swipe gesture, etc.) is received via the touch screen interface causing the slidable film reel element to move in a direction specified by the at least one gesture. Concurrently, the currently selected frame displayed within the preview portion of the video clip editor is continually changed so that it corresponds to the movement of slidable film reel element. Subsequently, user-generated input is received via the touch screen interface that activates the set start element to define a start point frame within the video clip. In addition, user-generated input is received via the touch screen interface that activates the set end element to define an end point frame within the video clip.

A segment can be generated by trimming at least a portion of the video clip so that it begins at the start point frame and ends at the end point frame.

At least a portion of the video clip can be duplicated beginning at the start point frame and ending at the end point frame. Such duplication can occur, for example, in response to activating a duplicate element.

The video clip editor can include a marker overlaying at least a portion of the reel element indicating the currently selected frame.

The video clip editor can include a split element which, when activated by user-generated input via the touch screen, causes the video clip to be split into two video clips at the currently selected frame. The two video clips can be made so they are visually distinct from each other (for example, one of the video clips can be blurred or otherwise separated).

The video clip editor can include a preview element which, when activated by user-generated input via the touch screen, causes at least a portion of the segment to be displayed within the preview portion.

The video clip editor can include a delete element which, when activated by user-generated input via the touch screen, causes any changes to be reset.

The video clip editor further can include a done element which, when activated by user-generated input via the touch screen, causes any changes to be saved.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter provides techniques for enhanced video editing on platforms such as mobile phones and tablet computers. In particular, the current subject matter allows a user to easily navigate (in some cases with one hand) frame-by-frame of a video segment and make various edits and the like.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a first view of a video clip editor;

FIG. 2 is a second view of a video clip editor;

FIG. 3 is a third view of a video clip editor; and

FIG. 4 is a process flow diagram illustrating editing of a video clip.

Like reference symbols in the various drawings indicate like elements.

### DETAILED DESCRIPTION

The current subject matter is directed to an application for a video clip editor for use on a device having a touch-screen interface. Example devices include, but are not limited to (unless otherwise specified), mobile phones (e.g., ANDROID phones, IPHONE phones, etc.) and tablet computers (e.g., ANDROID-based tablets, IPAD tablets). The video clip editor comprises a graphical user interface in which the various features are rendered. Such graphical user interface comprises a plurality of graphical user interface elements which, when activated (for example by user-generated input via the touch screen interface) cause one or more actions to occur. In some cases, the editing described below results in multiple new video files being generated while, in other cases, the original video file is unchanged with only its corresponding metadata being changed to reflect the edits. The current subject matter can be used in conjunction with the subject matter described in U.S. patent Ser. No. 13/710,317 entitled: “Video Editing, Enhancement and Distribution Platform for Touch Screen Computing Devices”, the contents of which are hereby fully incorporated by reference.

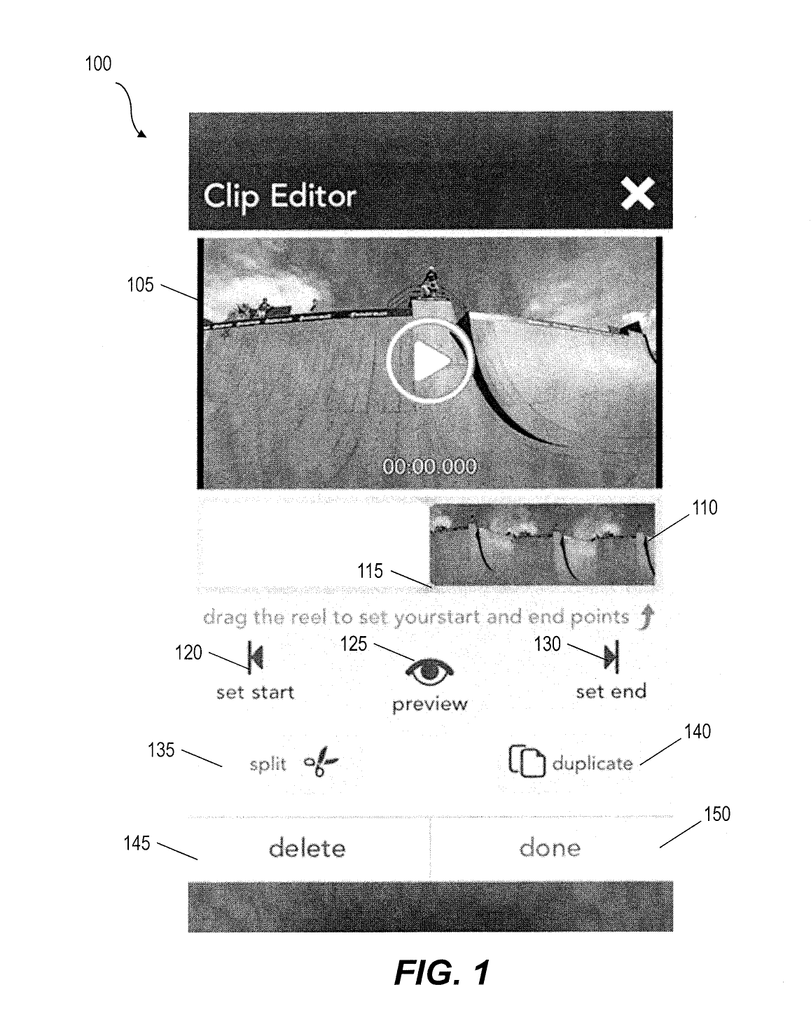

FIGS. 1-3 provide three respective views 100, 200, 300 of a video clip editor. The video clip editor can include a preview portion 105 in which a currently selected frame of a video clip that is being edited is displayed. In addition, the preview portion can display other information complementary to the selected frame including a timestamp and/or frame number. The preview portion 105 can have a corresponding graphical user interface element, which when activated, causes the video clip to be played from such point (e.g., at normal speed). The video clip editor can also include a slidable film reel element 110 having an overlaid visual characterization of frames within the video clip. Also included can be a marker 115 (which can be fixed or otherwise non-movable) that overlays the currently selected frame. Also included can be one or more of: a set start element 110, a preview element 125, a set end element 130, a split element 135, a duplicate element 140, a delete element 145, and a done element 150.

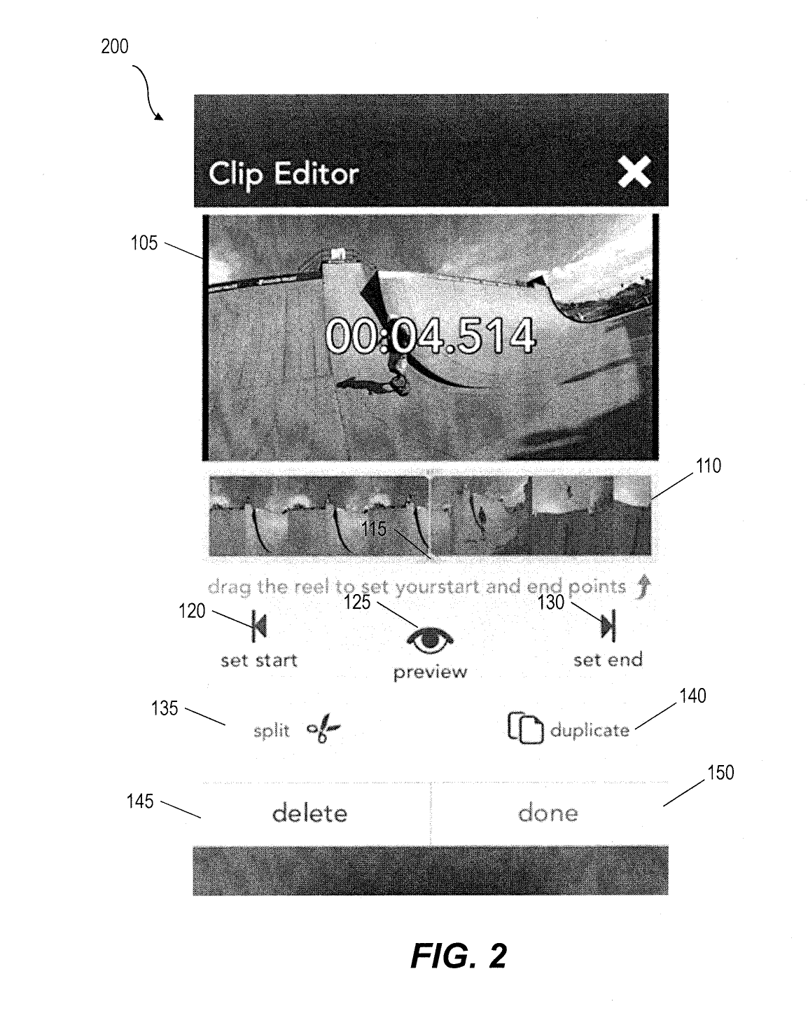

With reference to FIG. 1, a user can initiate a swiping gesture moving the position of frames within the slidable film reel element 110 leftwards so that a different frame of the video clip is displayed as part of the overlaid visual characterization of frames (as in FIG. 2). In addition, as the currently selected frame of the video clip has changed, so does the corresponding frame displayed in the preview portion 105 (this is done continuously as the slidable film reel element 110 is moved). The rate at which the frames displayed in the slidable film reel element 110 advance is dependent on the rate at which the gesture moves. It will be appreciated that the slidable film reel element can be moved both leftwards and rightwards.

With reference again to FIG. 1, a user can activate the set start element 120 which defines a start point frame for a segment to be generated (as part of an editing process). In this case, the segment starts at the beginning of the video clip at zero time stamp. Later, with reference to FIG. 2, and after the slidable film reel element 110 has been moved leftwards so that a frame corresponding to 4.514 seconds is displayed in the preview portion 105, a user can select the set end element 130 to define an end point frame for the segment. The remaining portions of the video clip are then trimmed (or made to be visually distinctive—such as blurry, etc.). The preview button 125 can be activated which results in some or all of the frames with the potentially newly defined start and end frames within the segment to be displayed in the preview portion 105.

In some cases, the split element 135 can be activated which causes the current frame as defined by the marker 115 to act as an end point frame and the next frame to act as a start point frame for two distinct segments (i.e., the video clip can be split at the frame corresponding to the marker 115).

Once the start point frame and the end point frame have been established, in some cases, using the duplicate element 140, the frames within such time span can be duplicated and concatenated with the segment.

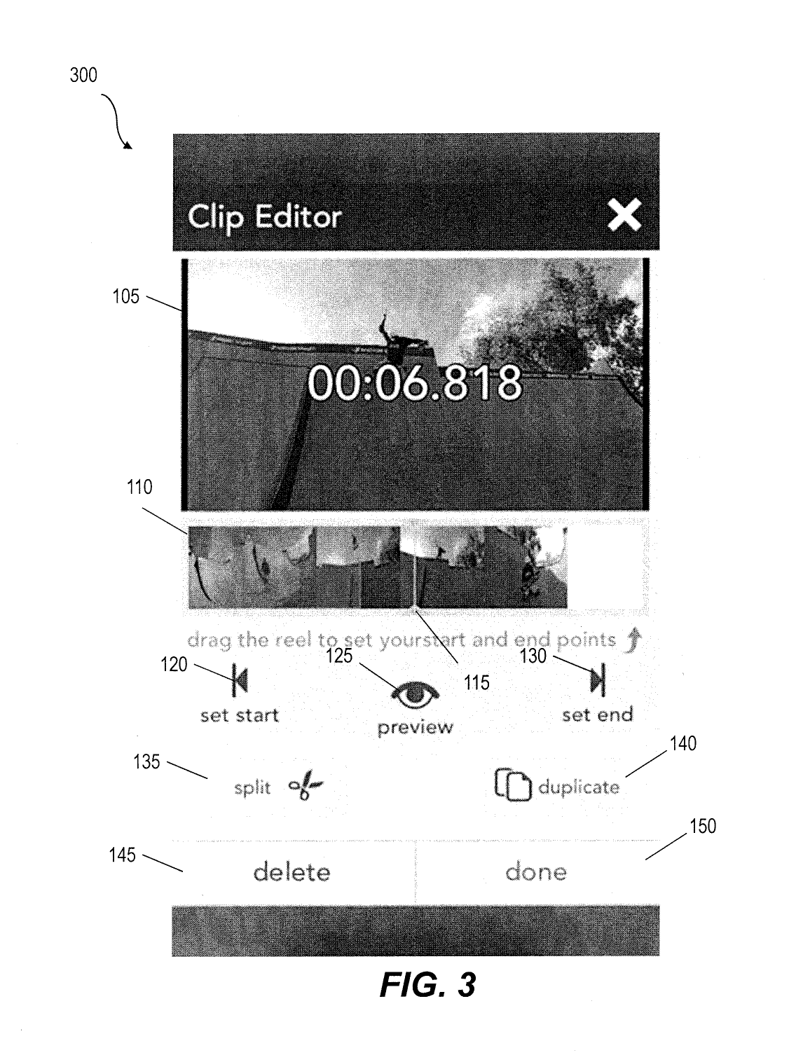

FIG. 3 shows an additional view in which the start point frame and the end point frame has been reset. This reset can be accomplished, for example, by activating the delete element 145. Similarly, any changes can be saved by activating the done element 150. When saved, the start and end segment markers apply meta data to the overall edit list to demark the new start and end points. The underlying video is not changed.

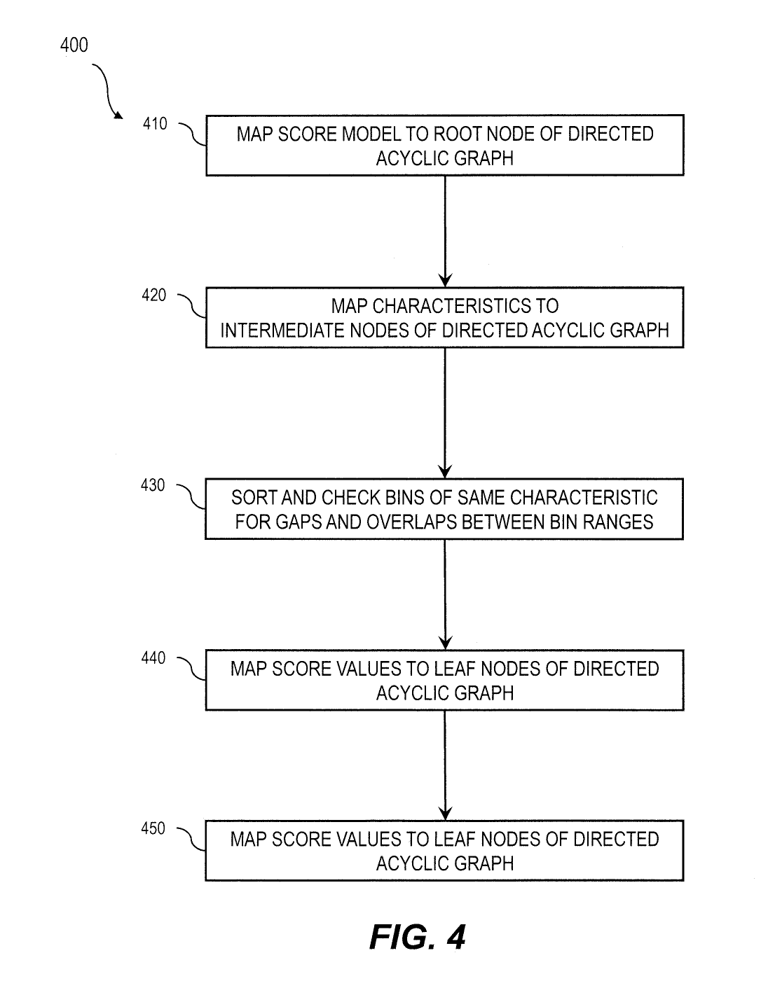

FIG. 4 is a diagram 400 illustrating a method in which, at 410, a video clip editor is rendered within a graphical user interface of a computing device that comprises a plurality of elements. The computing device has a touch screen interface for receiving user-generated input. The video clip editor comprises a preview portion showing a currently selected frame of a video clip being edited, a slidable film reel element having an overlaid visual characterization of frames within the video clip, a set start element, and a set end element. Thereafter, at 420, at least one gesture (e.g., a swipe, etc.) is received via the touch screen interface which causes the slidable film reel element to move in a direction specified by the at least one gesture. Concurrently, at 430, the currently selected frame displayed within the preview portion of the video clip editor is continuously changed so that it corresponds to the movement of slidable film reel element. User-generated input is received via the touch-screen interface, at 440, that activated the set start element to define a start point frame within the video clip. In addition, at 450, user-generated input is received via the touch screen interface activating the set end element to define an end point frame within the video clip. Once the start point frame and the end point frame are established, a segment can be defined, and/or the frames included therein can be duplicated. Other editing changes can be made including filters/effects for the frames including and between the start point frame and the end point frame.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like. The computing devices can include touch-screen devices such as mobile phones and tablet computers.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method comprising:
rendering a video clip editor within a graphical user interface of a computing device that comprises a plurality of elements, the computing device having a touch screen interface for receiving user-generated input, the video clip editor comprising a preview portion showing a currently selected frame of a video clip being edited, a slidable film reel element having an overlaid visual characterization of frames within the video clip, a set start element, and a set end element;
receiving at least one gesture via the touch screen interface causing the slidable film reel element to move in a direction specified by the at least one gesture;
continually changing the currently selected frame displayed within the preview portion of the video clip editor so that it corresponds to the movement of slidable film reel element;
receiving user-generated input via the touch screen interface activating the set start element to define a start point frame within the video clip; and
receiving user-generated input via the touch screen interface activating the set end element to define an end point frame within the video clip.

2. A method as in claim 1 further comprising:
generating a segment by trimming at least a portion of the video clip so that it begins at the start point frame and ends at the end point frame.

3. A method as in claim 1 further comprising:
duplicating at least a portion of the video clip beginning at the start point frame and ending at the end point frame.

4. A method as in claim 3, wherein the video clip editor further comprises a duplicate element and wherein the duplicating is initiated in response to the duplicate element being activated by user-generated input via the touch screen.

5. A method as in claim 1, wherein the video clip editor further comprises a marker overlaying at least a portion of the reel element indicating the currently selected frame.

6. A method as in claim 1, wherein the video clip editor further comprises a split element which, when activated by user-generated input via the touch screen, causes the video clip to be split into two video clips at the currently selected frame.

7. A method as in claim 6 further comprising:
making each of the two video clips are visually distinct from each other in the slidable film reel element.

8. A method as in claim 2, wherein the video clip editor further comprises a preview element which, when activated by user-generated input via the touch screen, causes at least a portion of the segment to be displayed within the preview portion.

9. A method as in claim 1, wherein the video clip editor further comprises a delete element which, when activated by user-generated input via the touch screen, causes any changes to be reset.

10. A method as in claim 1, wherein the video clip editor further comprises a done element which, when activated by user-generated input via the touch screen, causes any changes to be saved.

11. A non-transitory computer program product storing instructions which, when executed by at least one data processor, result in operations comprising:
rendering a video clip editor within a graphical user interface of a computing device that comprises a plurality of elements, the computing device having a touch screen interface for receiving user-generated input, the video clip editor comprising a preview portion showing a currently selected frame of a video clip being edited, a slidable film reel element having an overlaid visual characterization of frames within the video clip, a set start element, and a set end element;
receiving at least one gesture via the touch screen interface causing the slidable film reel element to move in a direction specified by the at least one gesture;
continually changing the currently selected frame displayed within the preview portion of the video clip editor so that it corresponds to the movement of slidable film reel element;
receiving user-generated input via the touch screen interface activating the set start element to define a start point frame within the video clip; and
receiving user-generated input via the touch screen interface activating the set end element to define an end point frame within the video clip.

12. A computer program product as in claim 11, wherein the operations further comprise:
generating a segment by trimming at least a portion of the video clip so that it begins at the start point frame and ends at the end point frame.

13. A computer program product as in claim 11, wherein the operations further comprise:
duplicating at least a portion of the video clip beginning at the start point frame and ending at the end point frame.

14. A computer program product as in claim 13, wherein the video clip editor further comprises a duplicate element and wherein the duplicating is initiated in response to the duplicate element being activated by user-generated input via the touch screen.

15. A computer program product as in claim 1, wherein the video clip editor further comprises a marker overlaying at least a portion of the reel element indicating the currently selected frame.

16. A computer program product as in claim 1, wherein the video clip editor further comprises a split element which, when activated by user-generated input via the touch screen, causes the video clip to be split into two video clips at the currently selected frame.

17. A computer program product as in claim 6, wherein the operations further comprise:
making each of the two video clips are visually distinct from each other in the slidable film reel element.

18. A computer program product as in claim 12, wherein the video clip editor further comprises a preview element which, when activated by user-generated input via the touch screen, causes at least a portion of the segment to be displayed within the preview portion.

19. A computer program product as in claim 11, wherein the video clip editor further comprises a delete element which, when activated by user-generated input via the touch screen, causes any changes to be reset.

20. A computer program product as in claim 11, wherein the video clip editor further comprises a done element which, when activated by user-generated input via the touch screen, causes any changes to be saved.
